(19) United States
(12) Patent Application Publication
(10) Pub. No.: US 2026/0077639 A1
(43) Pub. Date: Mar. 19, 2026

(54) VEHICLE FRAMEWORK STRUCTURE

(71) Applicant: TOYOTA JIDOSHA KABUSHIKI KAISHA, Toyota-shi (JP)

(72) Inventor: Daisuke MOTOI, Sanda-shi (JP)

(73) Assignee: TOYOTA JIDOSHA KABUSHIKI KAISHA, Toyota-shi (JP)

(21) Appl. No.: 19/238,951

(22) Filed: Jun. 16, 2025

(30) Foreign Application Priority Data
Sep. 17, 2024 (JP) 2024-160071

(51) Int. Cl. B60K 1/04; B62D 21/03

(52) U.S. Cl. CPC B60K 1/04; B62D 21/03; B60K 2001/0438

(57) ABSTRACT

The vehicle framework structure includes a framework main unit portion provided at an end portion in the vehicle width direction and extending in the vehicle front-rear direction and provided with an energy absorbing portion, and a frame portion provided at an inner side in the vehicle width direction of the framework main unit portion and integrally formed with the framework main unit portion and extending downward from the framework main unit portion to constitute a side frame of a battery case accommodating the battery.

### CROSS-REFERENCE TO RELATED APPLICATION

This application claims priority to Japanese Patent Application No. 2024-160071 filed on September 17, 2024. The disclosure of the above-identified application, including the specification, drawings, and claims, is incorporated by reference herein in its entirety.

### BACKGROUND

### 1. Technical Field

The present disclosure relates to a vehicle framework structure.

### 2. Description of Related Art

Japanese Unexamined Patent Application Publication No. 2018-202946 (JP 2018-202946 A) discloses a configuration in which a battery stack (battery) is disposed between a rocker which is a framework member of a vehicle body and a center tunnel. Specifically, by disposing the battery stack in a frame that is made up of right and left rockers, a front cross member, and a rear cross member, broad installation space for the battery stack is secured, without formation of dead space.

### SUMMARY

However, in the structure described in the above JP 2018-202946 A, collision load, which is input to the rocker in the event of a broadside collision of a vehicle, is input to the battery. Accordingly, there is room for improvement in protecting the battery in the event of a broadside collision, while securing broad installation space for the battery.

An object of the present disclosure is to provide a vehicle framework structure that is capable of protecting a battery in the event of a broadside collision, while securing broad installation space for the battery.

A vehicle framework structure according to a first aspect includes a framework main unit portion that is provided at an end portion in a vehicle width direction and extends in a vehicle front-rear direction, and that also includes an energy absorbing portion, and a frame portion that is integrally fashioned with the framework main unit portion, being provided on an inner side of the framework main unit portion in the vehicle width direction, and that also extends downward from the framework main unit portion to make up a side frame of a battery case for accommodating a battery.

In the vehicle framework structure according to the first aspect, the framework main unit portion is provided at the end portion thereof in the vehicle width direction, and this framework main unit portion extends in the vehicle front-rear direction. Also, the framework main unit portion includes the energy absorbing portion. The frame portion is provided on the inner side of the framework main unit portion in the vehicle width direction, and the frame portion is integrally formed with the framework main unit portion and extends downward from the framework main unit portion. Here, the frame portion makes up the side frame of the battery case that accommodates the battery. Thus, broad installation space can be secured for the battery as compared with when a side frame of the battery case is separately disposed on the inner side of the framework of the vehicle.

Further, the framework main unit portion includes the energy absorbing portion, and accordingly at least part of a collision load will be absorbed by the energy absorbing portion in the event of a broadside collision of the vehicle, and the collision load can be suppressed from being input to the frame portion.

With the vehicle framework structure according to a second aspect, in the first aspect, a floor cross member is provided extending in the vehicle width direction, on the inner side from the framework main unit portion in the vehicle width direction, and an end portion of the floor cross member in the vehicle width direction is fixed to the framework main unit portion.

In the vehicle framework structure according to the second aspect, the end portion of the floor cross member in the vehicle width direction is fixed to the framework main unit portion. Accordingly, the collision load that is input to the framework main unit portion can be conveyed to the floor cross member, and input of the collision load from the frame portion to the battery can be suppressed.

With the vehicle framework structure according to a third aspect, in the second aspect, an upper end portion of the frame portion is fixed to a lower end portion of the floor cross member.

In the vehicle framework structure according to the third aspect, the upper end portion of the frame portion is fixed to the lower end portion of the floor cross member. Accordingly, the collision load that is input to the frame portion can be conveyed to the floor cross member, and input of the collision load to the battery can be suppressed.

The vehicle framework structure according to a fourth aspect further includes, in the first aspect, a front cross member that is provided on an inner side of the frame portion in the vehicle width direction, at a front end portion of the frame portion, and that extends in the vehicle width direction, a rear cross member that is provided on an inner side of the frame portion in the vehicle width direction, at a rear end portion of the frame portion, and that extends in the vehicle width direction, and a share panel that is attached to a lower face of the frame portion, a lower face of the front cross member, and a lower face of the rear cross member, to support the battery from below.

In the vehicle framework structure according to the fourth aspect, a battery frame that protects the battery by the front cross member, the rear cross member, and the frame portion, can be made.

With the vehicle framework structure according to a fifth aspect, in the first aspect, the energy absorbing portion is made up including a plurality of main-unit-side hollow portions that is provided on the inner side of the framework main unit portion, the frame portion extends downward from a portion of the framework main unit portion that is a lower end portion, and also is an inner end portion in the vehicle width direction, and a frame-side hollow portion that extends in a vehicle up-down direction, and that also at least partially overlaps with the main-unit-side hollow portions as viewed from the vehicle width direction, is provided inside the frame portion.

In the vehicle framework structure according to the fifth aspect, collision energy can be absorbed by the main-unit-side hollow portions that are provided inside the framework main unit portion collapsing. Similarly, collision energy can be absorbed by the frame-side hollow portion that is provided inside the frame portion collapsing. Also, the frame-side hollow portion overlaps with the main-unit-side hollow portion as viewed from the vehicle width direction, and accordingly collision energy that is input from the frame portion to the battery in the event of a broadside collision can be absorbed by both the main-unit-side hollow portion and the frame-side hollow portion.

As described above, according to the vehicle framework structure of the present disclosure, the battery can be protected in the event of a broadside collision while securing broad mounting space for the battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded perspective view illustrating a main part of a vehicle including a vehicle framework structure according to an embodiment; and

FIG. 2 is a cross-sectional view taken along line 2-2 of FIG. 1.

### DETAILED DESCRIPTION OF EMBODIMENTS

A vehicle framework structure according to an embodiment will be described with reference to the drawings.

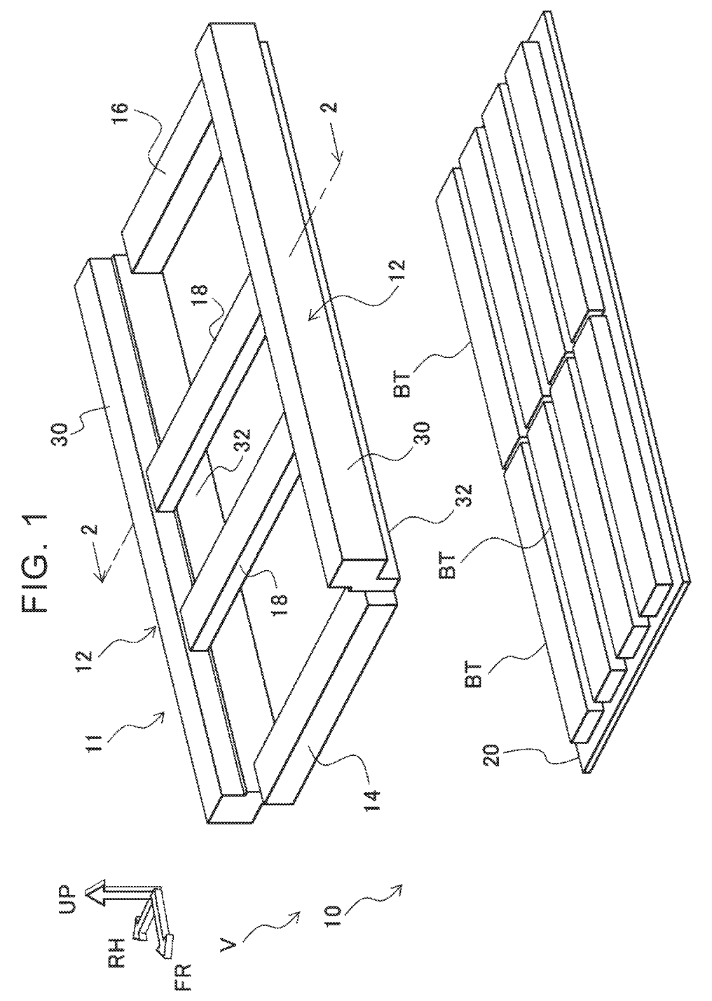

FIG. 1 is an exploded perspective view showing a main part of a vehicle V to which a vehicle framework structure according to an embodiment is applied. Note that the arrow FR, the arrow UP, and the arrow RH in the drawing indicate the vehicle front direction, the vehicle upper direction, and the vehicle left direction in the vehicle V, respectively. In the following description, when the front, rear, up, down, and left and right directions are used without special mention, the front and rear directions in the vehicle front-rear direction, the up and down directions in the vehicle up-down direction, and the left and right directions in the vehicle left-right direction (width direction) are respectively indicated.

As shown in FIG. 1, the vehicle V of the present embodiment includes a battery BT. The battery BT is disposed at a lower portion of the vehicle V and is supported by the share panel 20. The battery BT is, for example, a battery module in which a plurality of battery cells are accommodated, and in the present embodiment, eight battery BT are arranged, but the number of battery BT mounted on the vehicles V is not particularly limited. The eight battery BT are electrically connected to a drive motor (not shown) and are used as a secondary battery capable of storing electric power for supplying electric power to the drive motor.

It should be noted that the vehicle V can be widely applied to a vehicle that utilizes electric power as at least a part of a drive source, such as hybrid electric vehicle (HV: Hybrid Vehicle) and plug-in hybrid electric vehicle (PHEV: Plug‐in Hybrid Electric Vehicle), in addition to a BEV (Battery Electric Vehicle) where only a drive motor is used as a drive source.

The battery BT is housed inside the battery case 10. The battery case 10 includes a battery frame 11 formed in a substantially frame shape, and the battery frame 11 includes a pair of left and right rockers 12, a front cross member 14, and a rear cross member 16.

The rockers 12 are provided at both end portions in the vehicle width direction and extend in the vehicle front-rear direction. Details of the rocker 12 will be described later.

The front cross member 14 is provided at the front of the vehicle, and extends in the vehicle width direction to connect the front end portions of the left and right rockers 12 in the vehicle width direction. Specifically, the front cross member 14 is formed by a steel plate or the like into a closed cross-sectional structure having a substantially rectangular cross section, and the right end portion of the front cross member 14 is joined to the rocker 12 disposed on the right side. The left end portion of the front cross member 14 is joined to a rocker 12 disposed on the left side.

The joining method of the front cross member 14 and the rocker 12 is not particularly limited. For example, both end portions of the front cross member 14 and the rocker 12 may be joined by welding such as spot welding. Fasteners such as bolts, nuts, rivets, etc. may also be used to join both end portions of the front cross member 14 and the rocker 12.

In addition to the steel sheet, the front cross member 14 may be integrally formed by extrusion and casting of metal. The same applies to the rear cross member 16 described later.

The rear cross member 16 is provided at the vehicle rear portion and extends in the vehicle width direction to connect the rear end portions of the left and right rockers 12 in the vehicle width direction. Specifically, the rear cross member 16 is formed by a steel plate or the like into a closed cross-sectional structure having a substantially rectangular cross section, and the right end portion of the rear cross member 16 is joined to the rocker 12 disposed on the right side. The left end portion of the rear cross member 16 is joined to a rocker 12 disposed on the left side.

Between the front cross member 14 and the rear cross member 16, two floor cross members 18 extending in the vehicle width direction are provided. The floor cross member 18 has a closed cross-sectional structure having a substantially rectangular cross section like the front cross member 14 and the rear cross member 16, and a right end portion of the floor cross member 18 is directly or indirectly joined to the rocker 12. Also, the left end portion of the floor cross member 18 is directly or indirectly joined to the rocker 12.

The share panel 20 supporting the battery BT is attached to the lower face of the rocker 12, the lower face of the front cross member 14, and the lower face of the rear cross member 16.

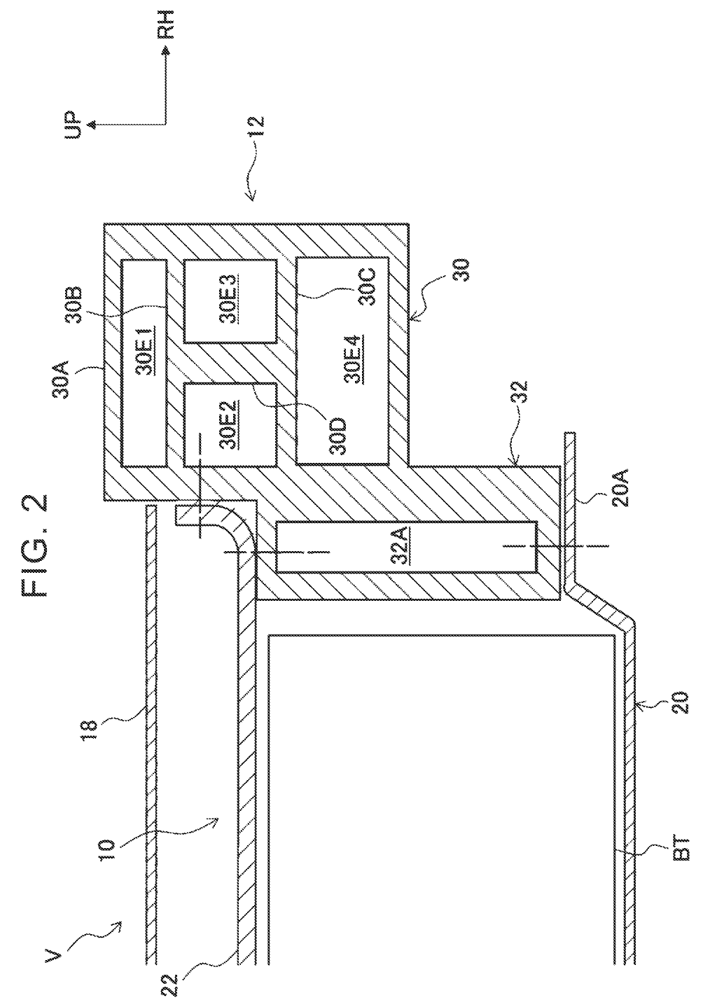

FIG. 2 is a cross-sectional view taken along line 2-2 of FIG. 1. As shown in FIG. 2, the rocker 12 includes a framework main unit portion 30 located on the vehicle width direction outer side, and a frame portion 32 located on the vehicle width direction inner side relative to the framework main unit portion 30.

The framework main unit portion 30 includes an outer peripheral portion 30A having a substantially rectangular frame shape when viewed from the front-rear direction of the vehicle, and an upper lateral wall 30B, a lower lateral wall 30C, and a vertical wall 30D are provided inside the outer peripheral portion 30A. Further, the framework main unit portion 30 is integrally formed with the frame portion 32 by extrusion molding of metal or the like.

The upper lateral wall 30B is provided above the vehicle up-down direction central part of the framework main unit portion 30, and partitions the inner space of the framework main unit portion 30 up and down. Specifically, the right end portion of the upper lateral wall 30B is connected to the right inner wall of the framework main unit portion 30, and the left end portion of the upper lateral wall 30B is connected to the left inner wall of the framework main unit portion 30. Therefore, the first main-unit-side hollow portion 30E1 is provided between the upper portion of the outer peripheral portion 30A of the framework main unit portion 30 and the upper lateral wall 30B.

The lower lateral wall 30C is provided below the vehicle-up-down direction central portion of the framework main unit portion 30, and vertically partitions the inner space of the framework main unit portion 30. Specifically, the right end portion of the lower lateral wall 30C is connected to the right inner wall of the framework main unit portion 30, and the left end portion of the upper lateral wall 30B is connected to the left inner wall of the framework main unit portion 30.

The vertical wall 30D extends in the vehicle up-down direction, an upper end of the vertical wall 30D is connected to a vehicle width direction central portion of the upper lateral wall 30B, and a lower end of the vertical wall 30D is connected to a vehicle width direction central portion of the lower lateral wall 30C.

Here, a second main-unit-side hollow portion 30E2 is provided in an area surrounded by the left wall of the outer peripheral portion of the framework main unit portion 30, the upper lateral wall 30B, the lower lateral wall 30C, and the vertical wall 30D. A third main-unit-side hollow portion 30E3 is provided in an area surrounded by the right wall of the outer peripheral portion of the framework main unit portion 30, the upper lateral wall 30B, the lower lateral wall 30C, and the vertical wall 30D.

In the present embodiment, the vertical wall 30D is arranged such that the second main-unit-side hollow portion 30E2 and the third main-unit-side hollow portion 30E3 have substantially the same size, but the present disclosure is not limited thereto.

A fourth main-unit-side hollow portion 30E4 is provided below the second main-unit-side hollow portion 30E2 and the third main-unit-side hollow portion 30E3 in an area surrounded by the lower portion and the lower lateral wall 30C of the outer peripheral portion 30A of the framework main unit portion 30. In the present embodiment, the fourth main-unit-side hollow portion 30E4 is a space larger than the first main-unit-side hollow portion 30E1, but is not limited thereto.

The first main-unit-side hollow portion 30E1, the second main-unit-side hollow portion 30E2, the third main-unit-side hollow portion 30E3, and the fourth main-unit-side hollow portion 30E4 provided in the framework main unit portion 30 constitute an energy absorbing portion. The energy absorbing portion absorbs at least a part of the collision load by collapsing the framework main unit portion 30 when the broadside collision of the vehicle V. In the following explanation, when the first main-unit-side hollow portion 30E1, the second main-unit-side hollow portion 30E2, the third main-unit-side hollow portion 30E3, and the fourth main-unit-side hollow portion 30E4 are used without distinction, they are simply referred to as "main-unit-side hollow portion 30E".

The frame portion 32 is provided on the vehicle width direction inner side of the framework main unit portion 30 and extends downward from the framework main unit portion. Here, the frame portion 32 constitutes a side frame of the battery case 10. That is, the frame portion 32 of the rocker 12 constitutes the side frame of the battery case 10.

The frame portion 32 extends downward from a lower end portion of the framework main unit portion 30 and an inner end portion in the vehicle widthwise direction, and a frame-side hollow portion 32A extending in the vehicle up-down direction is provided inside the frame portion 32.

The frame-side hollow portion 32A is formed to be long in the vehicle up-down direction when viewed from the vehicle front-rear direction, and a part of the frame-side hollow portion 32A overlaps with the fourth main-unit-side hollow portion 30E4 when viewed from the vehicle widthwise direction.

Here, the battery case 10 includes a case upper 22. The case upper 22 is formed of metal in a substantially rectangular plate shape, and the end portion of the case upper 22 in the vehicle width direction abuts against the framework main unit portion 30 and is curved toward the vehicle upper side. The vehicle width end portion of the case upper 22 and the framework main unit portion 30 are mechanically fastened by fasteners (not shown). As described above, in the present embodiment, since the case upper 22 functions as a floor panel, a separate floor panel is not provided. In FIG. 1, the case upper 22 is omitted for convenience of explanation.

The floor cross member 18 is fixed to the upper surface of the case upper 22, and the vehicle width direction end portion of the floor cross member 18 is mechanically fastened to the framework main unit portion 30 by a fastener (not shown). Note that a bracket may be provided between the floor cross member 18 and the framework main unit portion 30, and the floor cross member 18 and the framework main unit portion 30 may be joined via the bracket.

Further, the floor cross member 18 is fixed to the upper end portion of the frame portion 32 via the case upper 22. Note that the floor cross member 18 may be formed in a substantially hat-shaped cross section, and the floor cross member 18 may be fastened together with the case upper 22 to the frame portion 32 by a fastener in a state in which the flange of the floor cross member 18 is superimposed on the case upper 22.

Further, a share panel 20 is fixed to the lower face of the frame portion 32. Specifically, the outer peripheral end portion 20A of the share panel 20 is located above the other portion of the vehicle, and the outer peripheral end portion 20A is fastened to the frame portion 32 by a fastener (not shown) while being superimposed on the lower face of the frame portion 32.

### Operations

Next, the operation of the vehicle framework structure according to the present embodiment will be described.

As shown in FIG. 1, in the vehicle V to which the vehicle framework structure according to the present embodiment is applied, a framework main unit portion 30 constituting the rocker 12 is provided at an end portion in the vehicle width direction, and the framework main unit portion 30 extends in the vehicle front-rear direction.

Further, in the present embodiment, a frame-shaped battery frame that protects the battery can be configured by the front cross member 14, the rear cross member 16, and the frame portion 32.

Further, as shown in FIG. 2, the inside of the framework main unit portion 30 includes an energy absorbing portion including a first main-unit-side hollow portion 30E1, a second main-unit-side hollow portion 30E2, a third main-unit-side hollow portion 30E3, and a fourth main-unit-side hollow portion 30E4. Accordingly, when the broadside collision of the vehicle occurs, the collision load is input to the framework main unit portion 30, and the framework main unit portion 30 is crushed to absorb the collision load.

Further, a frame portion 32 is integrally provided on the vehicle width direction inner side of the framework main unit portion 30, and the frame portion 32 extends downward from the framework main unit portion 30 to constitute a side frame of the battery case 10. As a result, the mounting space of the battery BT can be secured larger than when the side frame of the battery case is separately disposed inside the framework of the vehicle V. That is, it is possible to protect the battery BT in the case of a broadside collision while securing a large mounting space of the battery BT.

Further, in the present embodiment, the vehicle width direction end portion of the floor cross member 18 is fixed to the framework main unit portion 30. Therefore, the collision load input to the framework main unit portion 30 can be transmitted to the floor cross member 18, and the input of the collision load from the frame portion 32 to the battery BT can be suppressed. That is, since the floor cross member 18 bears the collision load due to the load path through which the load flows from the framework main unit portion 30 to the floor cross member 18, it is possible to prevent the collision load from being transmitted from the frame portion 32 to the battery BT.

Further, in the present embodiment, the upper end portion of the frame portion 32 is fixed to the lower end portion of the floor cross member 18. Therefore, the collision load input to the frame portion 32 can be transmitted to the floor cross member 18, and the input of the collision load to the battery BT can be suppressed.

Furthermore, in the present embodiment, the plurality of main-unit-side hollow portions 30E provided inside the framework main unit portion 30 are collapsed to absorb the impact energy. Similarly, the frame-side hollow portion 32A provided inside the frame portion 32 is collapsed to absorb the impact-energy.

Here, the frame-side hollow portion 32A overlaps with the fourth main-unit-side hollow portion 30E4 when viewed from the vehicle-width direction. Therefore, the collision energy inputted from the frame portion 32 to the battery BT at the time of the broadside collision can be absorbed by both the main-unit-side hollow portion 30E and the frame-side hollow portion 32A.

Although the vehicle framework structure according to the present disclosure has been described above, it is needless to say that the present disclosure can be implemented in various forms without departing from the gist of the present disclosure. For example, in the above-described embodiment, the energy absorbing portion is configured by the four main-unit-side hollow portions 30E provided in the framework main unit portion 30, but the present disclosure is not limited thereto, and may be a structure configured to include other energy absorbing portions. As an example, a separate energy absorbing portion formed of a foamed resin material or the like may be provided inside the framework main unit portion having a closed cross-sectional structure. Further, a separate energy absorbing portion may be provided outside the framework main unit portion.

In the above-described embodiment, four main-unit-side hollow portions 30E are provided, but the present disclosure is not limited thereto, and the shapes and sizes of the main-unit-side hollow portions 30E may be changed. For example, the vertical wall 30D may be eliminated and a structure may be made in which three main-unit-side hollow portions are provided in the up-down direction.

Further, in the above-described embodiment, the rocker 12 includes the framework main unit portion 30 and the frame portion 32, but the present disclosure is not limited thereto. For example, a rocker may be formed by providing a panel formed by pressing a steel plate on the outside of the framework main unit portion 30 and the frame portion 32, and covering a part of the framework main unit portion 30 and the frame portion 32 with a panel.

With respect to the above embodiments, the following supplementary notes are disclosed.

### Appendix 1

A vehicle framework structure, comprising:

a framework main unit portion provided at an end portion in the vehicle width direction and extending in the vehicle front-rear direction and having an energy absorbing portion, a frame portion integrally formed with the framework main unit portion is provided on the vehicle width direction inner side of the framework main unit portion, and extends downward from the framework main unit portion to constitute a side frame of a battery case for accommodating a battery.

### Appendix 2

A floor cross member extending in the vehicle width direction is provided on an inner side in the vehicle width direction than the framework main unit portion.

The vehicle framework structure according to Appendix 1, wherein a vehicle width direction end portion of the floor cross member is fixed to the framework main unit portion.

### Appendix 3

The vehicle framework structure according to claim 2, wherein an upper end portion of the frame portion is fixed to a lower end portion of the floor cross member.

### Appendix 4

The vehicle framework structure according to any one of Appendices 1 to 3, further comprising: a front cross member provided on the vehicle width direction inner side at the front end portion of the frame portion and extending in the vehicle width direction, a rear cross member provided on the vehicle width direction inner side at the rear end portion of the frame portion and extending in the vehicle width direction, a share panel that is attached to a lower face of the frame portion, a lower face of the front cross member, and a lower face of the rear cross member, to support the battery from below.

### Appendix 5

The energy absorbing portion is configured to include a plurality of main-unit-side hollow portions provided inside the framework main unit portion, The frame portion extends downward from the lower end portion and the vehicle width direction inner end portion of the framework main unit portion, The vehicle framework structure according to any one of Appendices 1 to 4, wherein a frame-side hollow portion extending in the vehicle up-down direction and at least partially overlapping the main-unit-side hollow portion when viewed from the vehicle width direction is provided inside the frame portion.

What is claimed is:

1. A vehicle framework structure, comprising:
a framework main unit portion that is provided at an end portion in a vehicle width direction and extends in a vehicle front-rear direction, and that also includes an energy absorbing portion; and
a frame portion that is integrally fashioned with the framework main unit portion, being provided on an inner side of the framework main unit portion in the vehicle width direction, and that also extends downward from the framework main unit portion to make up a side frame of a battery case for accommodating a battery.

2. The vehicle framework structure according to claim 1, wherein
a floor cross member is provided extending in the vehicle width direction, on the inner side from the framework main unit portion in the vehicle width direction, and
an end portion of the floor cross member in the vehicle width direction is fixed to the framework main unit portion.

3. The vehicle framework structure according to claim 2, wherein an upper end portion of the frame portion is fixed to a lower end portion of the floor cross member.

4. The vehicle framework structure according to claim 1, further comprising:
a front cross member that is provided on an inner side of the frame portion in the vehicle width direction, at a front end portion of the frame portion, and that extends in the vehicle width direction;
a rear cross member that is provided on an inner side of the frame portion in the vehicle width direction, at a rear end portion of the frame portion, and that extends in the vehicle width direction; and
a share panel that is attached to a lower face of the frame portion, a lower face of the front cross member, and a lower face of the rear cross member, to support the battery from below.

5. The vehicle framework structure according to claim 1, wherein
the energy absorbing portion is made up including a plurality of main-unit-side hollow portions that is provided on the inner side of the framework main unit portion,
the frame portion extends downward from a portion of the framework main unit portion that is a lower end portion, and also is an inner end portion in the vehicle width direction, and
a frame-side hollow portion that extends in a vehicle up-down direction, and that also at least partially overlaps with the main-unit-side hollow portions as viewed from the vehicle width direction, is provided inside the frame portion.
